(19) United States
(12) Patent Application Publication
(10) Pub. No.: US 2026/0141469 A1
(43) Pub. Date: May 21, 2026

(54) Mobile Application for Real-Time Legal Guidance, Interaction Documentation, and Emergency Response during Law Enforcement Encounters

(71) Applicant: Malachai DeBruce, Dover, DE (US)

(72) Inventor: Malachai DeBruce, Dover, DE (US)

(21) Appl. No.: 18/955,814

(22) Filed: Nov. 21, 2024

(51) Int. Cl. G06Q 50/18; G06F 12/14; G06Q 50/26

(52) U.S. Cl. CPC G06Q 50/182; G06F 12/1408; G06Q 50/265; G06F 2212/1052

(57) ABSTRACT

The present invention discloses a mobile application system designed to provide real-time legal guidance, secure documentation, and emergency response during encounters with law enforcement. The system incorporates artificial intelligence-based speech-to-text transcription, contextual legal analysis, and actionable advice tailored to user interactions and applicable laws. A recording module captures audio in real-time, while a context analysis module generates situationally appropriate “Do's” and “Don'ts” linked to relevant legal frameworks. The application features an emergency response module for immediate communication with predefined contacts, location sharing, and alert generation. Encrypted storage ensures secure handling of recordings and interaction logs for legal admissibility. Additionally, the application provides jurisdiction-specific legal insights, scenario-based guidance, and curated updates on user rights, empowering individuals to navigate interactions with confidence while fostering transparency and accountability.

### BACKGROUND OF THE INVENTION

### Field of Invention

The present invention pertains to mobile applications and digital platforms designed to provide real-time legal guidance, situational awareness, and interaction documentation during encounters with law enforcement authorities. Specifically, the invention relates to systems and methods for integrating artificial intelligence-driven legal advisory tools, transcription and analysis of interactions, emergency response mechanisms, and secure data management to enhance user safety, accountability, and compliance with applicable laws.

### Brief Summary of the Invention

The invention is a mobile application system that leverages artificial intelligence and secure digital technologies to assist users during interactions with law enforcement. The system includes real-time speech-to-text transcription capabilities, AI-driven legal guidance tailored to conversational context, and emergency response functionalities, such as one-touch communication with predefined contacts. It provides situational legal advice linked to relevant laws and offers scenario-specific guidance for encounters like traffic stops or emergencies. Encrypted storage ensures the security and legal admissibility of audio recordings and interaction logs. By integrating location-based legal insights, news updates, and secure cloud infrastructure, the invention fosters transparency, accountability, and user safety while addressing potential misuse of authority.

### BRIEF DESCRIPTION OF THE FIGURES

FIG. 1: depicts the user interface of the mobile application, highlighting the homepage, contacts tab, news/bulletin tab, and guidance screen

FIG. 2: The flow demonstrates the sequence of user interactions within the mobile application, from launching the app and accessing its core features to managing recorded data for future use.

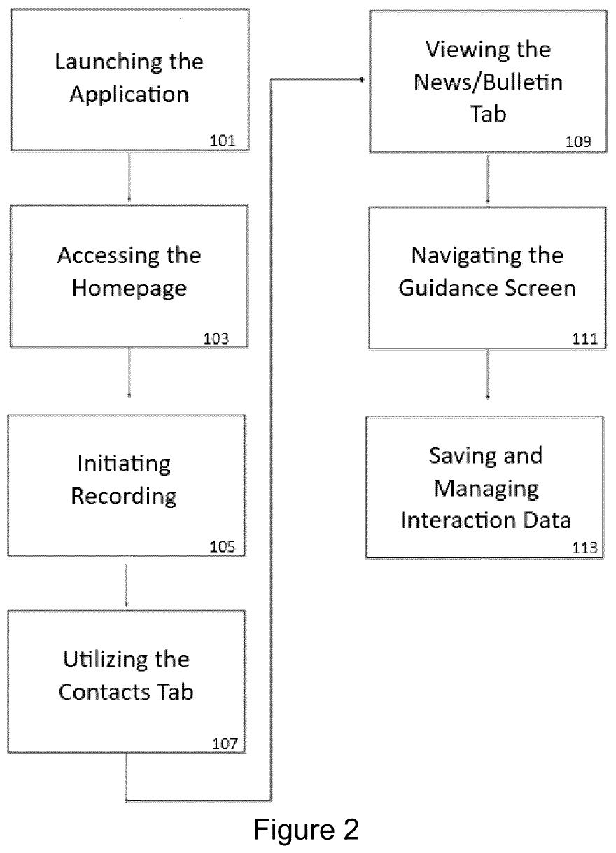

### DETAILED DESCRIPTION

The present invention relates to a novel system and method embodied in a mobile application designed to assist individuals during encounters with law enforcement officers by providing real-time legal guidance, secure documentation of interactions, and immediate emergency response mechanisms. The invention leverages state-of-the-art artificial intelligence (AI), natural language processing (NLP), and cloud-based technologies to enhance user safety, ensure accountability, and enable compliance with applicable legal frameworks.

The mobile application operates on Android and iOS platforms and is constructed using a cross-compatible framework such as Flutter to ensure seamless performance across devices. The application integrates functionalities for real-time speech-to-text transcription, context-aware legal advice, encrypted data storage, and emergency contact communication. These features collectively aim to empower users to navigate challenging situations with law enforcement while fostering transparency and adherence to the rule of law.

A principal feature of the invention is its real-time recording and guidance capability. The application employs an AI transcription model, such as Whisper AI, to transcribe user interactions into text in real time. This transcription is processed using advanced NLP models, including Llama-based frameworks, to analyze conversational content and generate actionable legal advice. Such advice is dynamically tailored to the context of the conversation and is categorized into actionable “Do's” and “Don'ts,” with explicit references to applicable statutes and rights, such as the Fourth Amendment or Miranda rights. For instance, during a routine traffic stop, the application may advise the user to request clarification on the reason for the stop or remind the user of their right to remain silent.

The invention further includes an emergency response mechanism, which allows users to configure a list of predefined contacts such as family members, attorneys, or legal aid organizations. A dedicated “panic button” feature facilitates instantaneous communication with these contacts, transmitting a predefined alert message along with the user's real-time location and interaction details. The application also enables direct calls or messages to primary contacts, ensuring timely assistance in critical situations.

The application provides situationally adaptive legal guidance through predefined categories such as “Traffic Stop,” “Medical Emergency,” and “Child on Board.” Each category delivers specialized advice tailored to the unique circumstances of the user's interaction with law enforcement. For example, during a medical emergency, the application prioritizes advice related to obtaining immediate medical care while documenting the interaction.

The invention incorporates a secure data management system that ensures the privacy and integrity of recorded audio, transcriptions, and interaction logs. All data is encrypted using AES-256 encryption, both at rest and during transmission, to safeguard against unauthorized access. Data transmissions are conducted via HTTPS and TLS protocols to ensure secure communication between the application and its cloud-based backend infrastructure. Additionally, user control over data sharing is a core feature, allowing users to manage access to recordings and logs, even in cases involving legal or law enforcement entities.

The technical architecture of the invention is designed for scalability and efficiency. The backend infrastructure utilizes Amazon Web Services (AWS), with AWS S3 providing encrypted cloud storage for audio files and logs, and AWS EC2 delivering computational resources for AI-driven analysis and transcription. A PostgreSQL database manages user profiles, emergency contact details, and interaction metadata. AI functionalities are powered by Whisper AI for transcription accuracy, Llama models for NLP-based legal guidance, and FAISS (Facebook AI Similarity Search) for rapid retrieval of relevant legal precedents and contextual advice.

To enhance usability in high-stress scenarios, the application's user interface emphasizes accessibility and speed. The homepage prominently features a one-tap recording button that activates transcription and guidance functionalities. Additional tabs include a contact management interface for emergency response and a news feed for curated updates on legal rights, judicial decisions, and law enforcement policies. State-specific and scenario-specific guidance is delivered dynamically, ensuring that the advice provided is legally accurate and jurisdictionally relevant.

The invention also addresses critical challenges related to security and responsiveness. Real-time data processing is secured with end-to-end encryption, ensuring that sensitive information is protected against interception or misuse. Session management features include automatic logout after periods of inactivity, token-based authentication for secure sessions, and forced logout for deactivated accounts to prevent unauthorized access.

This invention introduces innovative features, including real-time legal guidance contextualized to user interactions, adaptive scenario-based responses, and integration with legal databases for jurisdiction-specific advice. By providing a reliable and secure mechanism for documenting interactions and offering actionable legal insights, the invention significantly enhances transparency and accountability in law enforcement encounters while empowering users with knowledge of their legal rights.

The described system is particularly useful for individuals seeking to safeguard their rights during police interactions, legal aid organizations offering technological tools for client empowerment, and civil rights advocacy groups promoting accountability and transparency. By integrating advanced AI, robust security protocols, and user-centric design, the invention establishes a novel standard for mobile applications aimed at ensuring safety and legal protection during interactions with law enforcement.

### DETAILED DESCRIPTION OF FIGURES

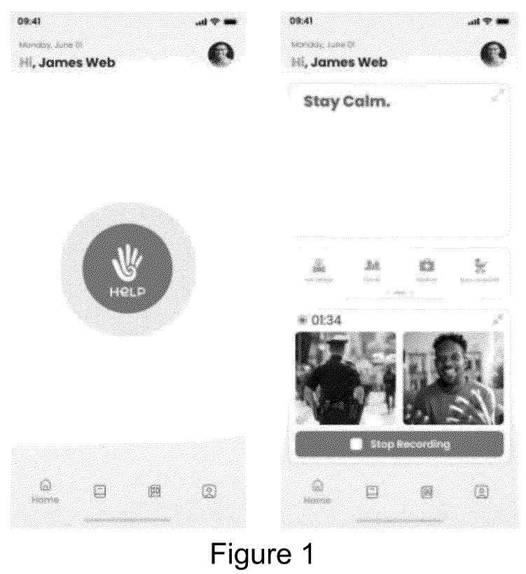

FIG. 1: illustrates the user interface of the mobile application, which emphasizes accessibility and speed, critical features in high-stress situations. The homepage prominently features a recording button, designed for immediate activation of transcription and legal guidance tools. The contacts tab displays emergency contacts in a simple list format, allowing users to make instant calls or send messages to predefined contacts. The news/bulletin tab provides a curated feed of legal updates, offering clickable articles for users to access detailed information. Lastly, the guidance screen dynamically displays actionable advice categorized into “Do's,” “Don'ts,” and legal statutes, based on the context of the recorded conversation.

### FIG. 1.101: Launching the Application

This step involves the user opening the mobile application, which initializes with a splash screen and directs the user to the main interface. The launch is optimized for speed and usability to ensure that users can access critical features promptly in high-stress situations.

### FIG. 1.103: Accessing the Homepage

Upon launching, the user is directed to the homepage, which prominently features the central recording button. The layout ensures that the most critical functionality, recording, is immediately accessible, along with navigational options for other key features.

### FIG. 1.105: Initiating Recording

In this step, the user taps the prominent recording button on the homepage, activating the real-time recording and transcription tools. Once activated, the app begins to capture audio and transcribe conversations while preparing to provide contextual legal guidance based on the input.

### FIG. 1.107: Utilizing the Contacts Tab

The user can navigate to the contacts tab to view a list of predefined emergency contacts. The tab presents contact details in a simple list format, allowing the user to initiate calls or send messages instantly with a single tap.

### FIG. 1.109: Viewing the News/Bulletin Tab

This step involves the user accessing the news/bulletin tab to browse curated updates and articles related to legal rights and public safety. The user can click on specific items to view detailed information about the selected topic.

### FIG. 1.111: Navigating the Guidance Screen

While the app records and transcribes audio, the user can view dynamically generated legal guidance on the guidance screen. This screen categorizes advice into actionable “Do's,” “Don'ts,” and references to applicable statutes, tailored to the conversation's context.

### FIG. 1.113: Saving and Managing Interaction Data

The final step enables the user to save recorded audio, transcriptions, and any associated metadata securely. Users can also manage these data files within the app, ensuring their accessibility for future reference or legal use.

What is claimed is:

1. A mobile application system for real-time legal guidance and interaction documentation during law enforcement encounters, comprising:
a. a recording module configured to capture audio of interactions between a user and law enforcement in real time;
b. a speech-to-text transcription module utilizing artificial intelligence to transcribe recorded audio into text;
c. a context analysis module configured to analyze transcriptions and provide actionable legal guidance specific to the user's situation;
d. an emergency response module allowing the user to instantly communicate with predefined emergency contacts, including sharing real-time location and alerting third parties;
e. an encrypted storage module for securely storing audio recordings, transcriptions, and associated metadata; and
f. a user interface module configured to present legal advice, emergency options, and other functionalities through an accessible graphical interface.

2. The system of claim 1, wherein the context analysis module is further configured to:
a. analyze recorded interactions using natural language processing (NLP) models;
b. identify key phrases indicative of law enforcement requests or legal violations; and
c. dynamically generate “Do's” and “Don'ts” linked to applicable laws and rights.

3. The system of claim 1, wherein the emergency response module comprises:
a. a one-tap button to send predefined alert messages to emergency contacts;
b. functionality to initiate voice calls or text messages to legal aid organizations or attorneys; and
c. a real-time location-sharing feature to transmit the user's geographical position to emergency contacts.

4. The system of claim 1, wherein the recording module is further configured to:
a. automatically detect the start of a law enforcement interaction using voice activation or manual input; and
b. upload recorded audio to a cloud-based storage system upon termination of the interaction.

5. The system of claim 1, wherein the encrypted storage module utilizes:
a. Advanced Encryption Standard (AES-256) for securing recordings and transcriptions at rest; and
b. Transport Layer Security (TLS) for encrypted data transmission between the mobile application and cloud-based servers.

6. The system of claim 1, wherein the user interface module further comprises:
a. a homepage with a prominently displayed recording button for immediate activation of the recording module;
b. a contact management interface for adding, editing, and accessing predefined emergency contacts;
c. a news feed interface providing state-specific legal updates, case summaries, and educational resources on legal rights; and
d. a dynamic legal guidance screen that presents real-time advice based on recorded audio and analyzed context.

7. A method for providing real-time legal guidance during law enforcement interactions, comprising:
a. recording audio of the interaction using a mobile application;
b. transcribing the recorded audio into text using artificial intelligence-based speech-to-text technology;
c. analyzing the transcription to detect legal context and generate actionable legal advice;
d. presenting the legal advice to the user through a mobile application interface in real time;
e. initiating an emergency response mechanism to alert predefined contacts and share the user's location, when triggered; and
f. securely storing the recorded audio, transcription, and associated metadata in an encrypted format.

8. The method of claim 7, further comprising:
a. integrating location-based legal databases to tailor legal guidance based on the user's geographical location;
b. updating legal advice dynamically based on changes in state-specific or country-specific laws; and
c. providing scenario-specific guidance through predefined categories such as “Traffic Stop,” “Medical Emergency,” or “Child on Board.”

9. The method of claim 7, wherein the transcription analysis comprises:
a. identifying critical legal phrases such as “search,” “arrest,” or “Miranda rights”;
b. correlating phrases with applicable legal frameworks; and
c. delivering advice through categorized messages such as “Do's” and “Don'ts.”

10. The method of claim 7, further comprising a cloud-based backend system configured to:
a. receive and process recorded audio and transcription data for additional legal analysis;
b. manage user profiles, emergency contacts, and metadata in a structured database; and
c. provide access to recorded interactions and legal insights through secure user authentication mechanisms.

11. A mobile application for legal protection during law enforcement encounters, wherein the application integrates:
a. real-time recording and transcription tools;
b. contextually-aware legal advisory functions powered by natural language understanding models;
c. one-tap emergency alert and response features; and
d. secure storage and management of interaction data to ensure privacy and legal admissibility.

12. The application of claim 11, wherein the legal advisory functions provide:
a. location-aware legal insights specific to the user's jurisdiction;
b. continuously updated legal precedents integrated via a legal database; and
c. adaptive feedback mechanisms to refine advice based on user input and interaction history.

13. The application of claim 11, further comprising a dynamic news and alert system configured to:
a. aggregate legal updates, news articles, and case law relevant to public safety and civil liberties; and
b. deliver state-specific alerts to the user regarding changes in legal rights or law enforcement policies.
